(19) United States
(12) Patent Application Publication
(10) Pub. No.: US 2025/0370172 A1
(43) Pub. Date: Dec. 4, 2025

(54) MIRROR WITH METAL FLUORIDE LAYERS AND METHOD OF MAKING THE SAME

(71) Applicant: CORNING INCORPORATED, CORNING, NY (US)

(72) Inventors: Jing Du, Pittsford, NY (US); Gary Allen Hart, Walworth, NY (US)

(21) Appl. No.: 19/216,987

(22) Filed: May 23, 2025

Related U.S. Application Data
(60) Provisional application No. 63/655,767, filed on Jun. 4, 2024.

(51) Int. Cl. G02B 5/08

(52) U.S. Cl. CPC G02B 5/0891

(57) ABSTRACT

A mirror including: (a) a substrate comprising a primary surface; (b) an aluminum layer disposed on the primary surface of the substrate, the aluminum layer having a thickness within a range of from 50 nm to 100 nm; (c) an MgF₂ layer disposed on the aluminum layer, the MgF₂ layer comprising a thickness within a range of from 3.0 nm to 7.0 nm; and (d) a second metal fluoride layer disposed on the MgF₂ layer, the second metal fluoride layer having a thickness within a range of from 5.0 nm to 40 nm. The mirror can exhibit greater than 70% reflectance at an angle of incidence of 15 degrees of electromagnetic radiation throughout an entirety of a wavelength range of from 115 nm to 220 nm.

This application claims the benefit of priority to U.S. Provisional Patent Application Ser. No. 63/655,767 filed on Jun. 4, 2024, the content of which is relied upon and incorporated herein by reference in its entirety.

### BACKGROUND

Semiconductor devices continue to decrease in size, as advanced lithography techniques allow for smaller feature sizes (e.g., processing nodes). While feature sizes of greater than 10 μm were the state of the art in the late 1960s, feature sizes of under 10 nm are the current state of the art. Even smaller features sizes may be inevitable.

Semiconductor devices are subject to inspection to ensure quality and lack of defects. Such inspection at the nanometer scale requires advanced optics. Such advanced optics are designed to manipulate electromagnetic radiation of a specific wavelength range. For example, some advanced optics are designed to manipulate deep-ultraviolet (DUV) wavelengths (e.g., 193.4 nm). Other examples include optics designed to manipulate vacuum ultraviolet (VUV) wavelengths (e.g., from 120 nm to 190 nm) and optics designed to manipulate extreme ultraviolet (EUV) wavelengths (e.g., 13.5 nm). Although the EUV wavelength is about ten times shorter than the VUV, many defects are optically more sensitive to the VUV wavelengths than the EUV wavelengths.

In addition, such advanced optics typically include reflective devices (e.g., mirrors). For example, VUV inspection options typically utilize mirrors designed to reflect VUV wavelengths. Aluminum is recognized as the material of choice for reflective optics for VUV wavelengths.

However, there is a problem in that the aluminum can oxidize to, for example, Al₂O₃. Oxidation of the aluminum is a problem, because the oxidized aluminum is less reflective than metallic aluminum of VUV wavelengths due to the increased absorption coefficient of Al₂O₃at those wavelengths. Thus, optical performance degrades as the aluminum oxidizes, which renders the optical system unsuitable to perform inspection services.

### SUMMARY

The present disclosure addresses that problem by following the vapor deposition of the reflective aluminum layer with a relatively thin and quickly deposited MgF₂ layer, also via vapor deposition in the same vacuum chamber where the aluminum layer was applied, and then vapor depositing a second metal fluoride layer over the MgF₂ layer. The MgF₂ layer is relatively thin and quickly applied to minimize the oxidation of the aluminum layer that occurs before the second metal fluoride layer is added. The second metal fluoride layer has a thickness greater than the MgF₂ layer and offers longer term protection of the aluminum layer from oxidation. The MgF₂ offers stop gap oxidation protection until the second metal fluoride layer can be applied.

According to a first aspect of the present disclosure, a mirror comprises: (a) a substrate comprising a primary surface; (b) an aluminum layer disposed on the primary surface of the substrate, the aluminum layer comprising a thickness within a range of from 50 nm to 100 nm; (c) an MgF₂ layer disposed on the aluminum layer, the MgF₂ layer comprising a thickness within a range of from 3.0 nm to 7.0 nm; and (d) a second metal fluoride layer disposed on the MgF₂ layer, the second metal fluoride layer comprising a thickness within a range of from 5.0 nm to 40 nm, wherein, the mirror exhibits greater than 70% reflectance at an angle of incidence of 15 degrees of electromagnetic radiation throughout an entirety of a wavelength range of from 115 nm to 120 nm.

According to a second aspect of the present disclosure, the mirror of the first aspect is presented, wherein the substrate comprises a composition of one or more of SiO₂, Ni-plated Al, pure Al, CaF₂, Si, and ultra-low expansion glass.

According to a third aspect of the present disclosure, the mirror of any one of the first through second aspects is presented, wherein the primary surface of the substrate upon which the aluminum layer is disposed exhibits a surface roughness (RMS) that is less than or equal to 10 Å.

According to a fourth aspect of the present disclosure, the mirror of any one of the first through third aspects is presented, wherein the mirror is substantially free of a layer of Al₂O₃ disposed between the aluminum layer and the MgF₂ layer.

According to a fifth aspect of the present disclosure, the mirror of any one of the first through fourth aspects is presented, wherein the thickness of the second metal fluoride layer is within a range of from 10 nm to 30 nm.

According to a sixth aspect of the present disclosure, the mirror of any one of the first through fifth aspects is presented, wherein the second metal fluoride layer comprises a metal fluoride of one or more of MgF₂, AlF₃, LiF, LaF₃, GdF₃, and CaF₂.

According to a seventh aspect of the present disclosure, the mirror of any one of the first through sixth aspects is presented, wherein the second metal fluoride layer has a higher packing density than the MgF₂ layer.

According to an eighth aspect of the present disclosure, the mirror of any one of the first through seventh aspects is presented, wherein the second metal fluoride layer comprises an external surface that exhibits a surface roughness (RMS) that is less than or equal to 10 Å.

According to a ninth aspect of the present disclosure, a method of making a mirror comprises: (a) a first vapor deposition step comprising vaporizing an aluminum source material with an energy source within a vacuum chamber at a near-vacuum pressure so that vaporized aluminum moves from the aluminum source material and condenses upon a substrate as an aluminum layer; (b) a second vapor deposition step commencing within 20 seconds after completion of the first vapor deposition step, the second vapor deposition step comprising vaporizing an MgF₂ source material within the vacuum chamber so that vaporized MgF₂ moves from the MgF₂ source and condenses upon the aluminum layer as a MgF₂ layer having a thickness within a range of from 3.0 nm to 7.0 nm; and (c) a third vapor deposition step, occurring after the second vapor deposition step, comprising vaporizing a metal fluoride source material so that vaporized metal fluoride moves from the metal fluoride source and condenses upon the MgF₂ layer as a second metal fluoride layer comprising (i) a thickness that is greater than the thickness of the MgF₂ layer and (ii) a packing density that is greater than a packing density of the MgF₂ layer.

According to a tenth aspect of the present disclosure, the method of the ninth aspect is presented, wherein during the first vapor deposition step, an electron beam vaporizes the source of aluminum.

According to an eleventh aspect of the present disclosure, the method of any one of the ninth through tenth aspects is presented, wherein the substrate comprises a composition one or more of SiO₂, Ni-plated Al, pure Al, CaF₂, Si, and ultra-low expansion glass.

According to a twelfth aspect of the present disclosure, the method of any one of the ninth through eleventh aspects is presented, wherein during the first vapor deposition step, the aluminum condenses on the substrate at a rate within a range of from 50 nm/second to 100 nm/second until the formation of the aluminum layer comprising a thickness within a range of from 50 nm to 100 nm is formed, at which thickness the first vapor deposition step ceases.

According to a thirteenth aspect of the present disclosure, the method of any one of the ninth through twelfth aspects is presented, wherein the second vapor deposition step begins before measurable oxidation of the aluminum layer occurs.

According to a fourteenth aspect of the present disclosure, the method of any one of the ninth through thirteenth aspects is presented, wherein the second vapor deposition step commences without the near-vacuum pressure within the vacuum chamber substantially changing after completion of the first vapor deposition step.

According to a fifteenth aspect of the present disclosure, the method of any one of the ninth through fourteenth aspects is presented, wherein (i) during the second vapor deposition step, an internal environment within the vacuum chamber has a second temperature; and (ii) during the third vapor deposition step, the internal environment within the vacuum chamber has a third temperature that is greater than the second temperature at which the second vapor deposition step occurred.

According to a sixteenth aspect of the present disclosure, the method of any one of the ninth through fifteenth aspects is presented, wherein (i) during the first vapor deposition step, an internal environment within the vacuum chamber has a first temperature of about room temperature; (ii) during the second vapor deposition step, the internal environment within the vacuum chamber has a second temperature of about room temperature; and (iii) the third vapor deposition step occurs at a temperature within a range of from 200° C. to 300° C.

According to a seventeenth aspect of the present disclosure, the method of any one of the ninth through sixteenth aspects is presented, wherein the second metal fluoride layer comprises a metal fluoride of one or more of MgF₂, AlF₃, LiF, LaF₃, GdF₃, and CaF₂.

According to an eighteenth aspect of the present disclosure, the method of any one of the ninth through seventeenth aspects is presented, wherein the thickness of the second metal fluoride layer is within a range of from 5.0 nm to 40 nm.

According to a nineteenth aspect of the present disclosure, the method of any one of the ninth through eighteenth aspects further comprises a polishing step, occurring before the first vapor deposition step, comprising polishing the primary surface of the substrate to achieve a surface roughness (RMS) that is less than or equal to 10 Å.

According to a twentieth aspect of the present disclosure, the method of any one of the ninth through nineteenth aspects further comprises a baking step, occurring before the first vapor deposition step, comprising subjecting the substrate, while in the vacuum chamber, to an internal environment comprising a baking temperature above 130° C. for a baking time period of at least 8 hours.

According to a twenty-first aspect of the present disclosure, the method of any one of the ninth through twentieth aspects is presented, wherein the energy source used to vaporize the aluminum source material during the first vapor deposition step is the energy source used to vaporize the MgF₂ source material during the second vapor deposition step.

### BRIEF DESCRIPTION OF THE DRAWINGS

In the Drawings:

FIG. 1 is schematic cross-sectional view of a mirror of the present disclosure reflecting incident electromagnetic radiation;

FIG. 2 is an elevation view of a cross-section of the mirror of FIG. 1, illustrating the mirror including a substrate, an aluminum layer on the substrate, an MgF₂ layer on the aluminum layer, and a second metal fluoride layer on the MgF₂ layer;

FIG. 3 is a schematic flow chart of a method of the present disclosure of making the mirror of FIG. 1, illustrating a first vapor deposition step to add the aluminum layer, a second vapor deposition step to add the MgF₂ layer, and a third vapor deposition step to add the second metal fluoride layer;

FIG. 4 is schematic flow chart of the first vapor deposition step, the second vapor deposition step, and the third vapor deposition step, illustrating all three steps occurring in the same vacuum chamber but, in embodiments, with different source materials for each of the three steps;

FIG. 5 is a graph of reflectance spectra for Example 1 and Comparative Examples 1A and 1B, illustrating the mirror of Example 1 exhibiting higher reflectance throughout the entirety of the 120 nm to 150 nm wavelength range;

FIG. 6 is a graph of theoretical reflectance spectra for Examples 2A-2C, illustrating that the reflectance that the mirror exhibits varies as a function of the metal fluoride chosen to protect the aluminum layer from oxidation;

FIG. 7 is a graph of reflectance spectra for Comparative Example 3A and Examples 3B-3H, illustrating that the reflectance that the mirror exhibits varies as a function of thickness of the MgF₂ layer, the metal fluoride chosen for the second metal fluoride layer, and the thickness of the second metal fluoride layer;

FIG. 8 is a graph of reflectance spectra for Examples 4A-4C, illustrating that the reflectance that the mirror exhibits varies as a function of the surface roughness (RMS) of the substrate upon which the aluminum layer, the MgF₂ layer, and the second metal fluoride layer are disposed;

FIG. 9 is an atomic force microscopy image of the mirror of Example 5, illustrating a surface roughness (RMS) of about 8 Å;

FIG. 10 is an atomic force microscopy image of the mirror of Example 6A, illustrating a surface roughness (RMS) of about 6 Å;

FIG. 11 is a graph of reflectance spectra for Examples 6A-6C, illustrating that the reflectance that the mirror exhibits varies as a function of the surface roughness (RMS) of the substrate upon which the aluminum layer, the MgF₂ layer, and the second metal fluoride layer are disposed; and

FIG. 12 is graph of reflectance spectra for Example 7A and Comparative Example 7B, illustrating that the reflectance that a mirror of the present disclosure with the flash-deposited MgF₂ layer exhibits is greater than a mirror without the flash-deposited MgF₂ layer, suggesting that the lack of the flash-deposited MgF₂ layer permits oxidation of the aluminum layer to occur, which hinders the reflectance that the mirror exhibits.

### DETAILED DESCRIPTION

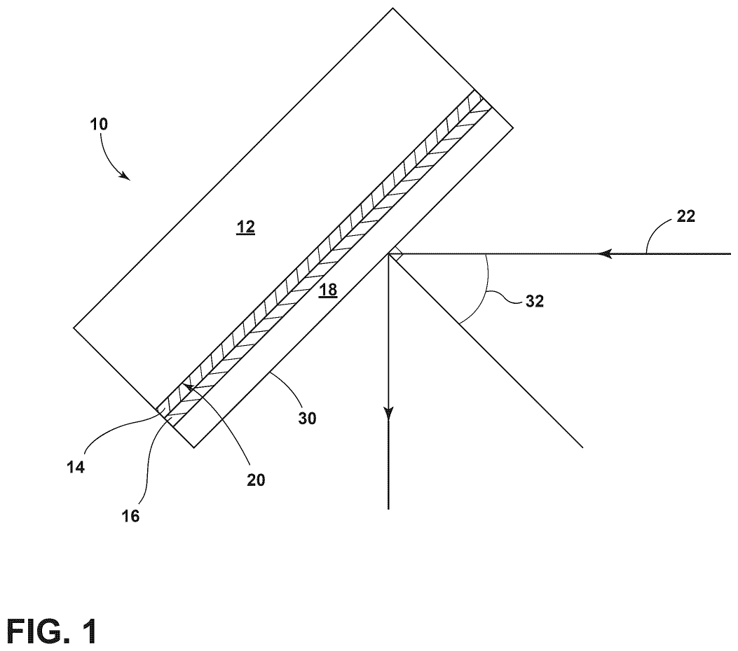

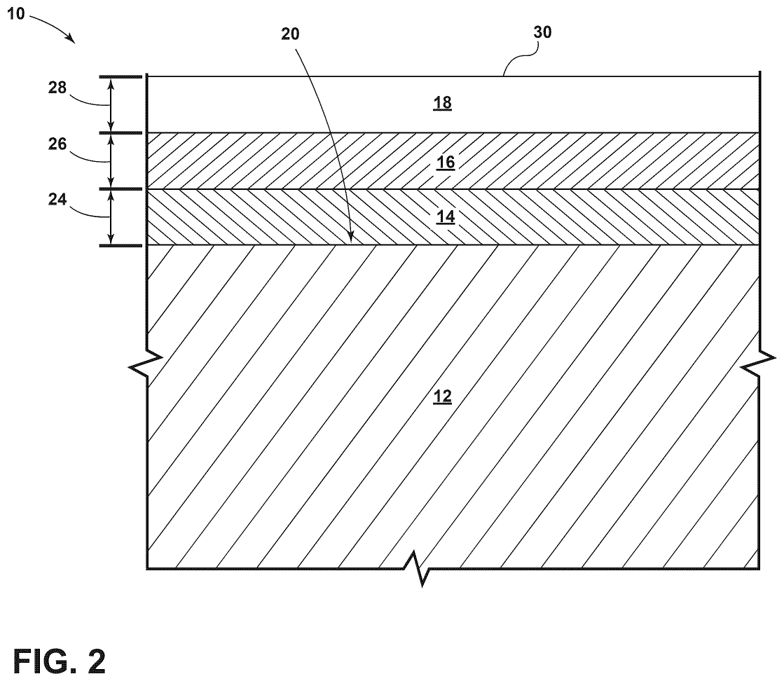

Referring to FIGS. 1 and 2, a mirror 10 includes a substrate 12, an aluminum layer 14, an MgF₂ layer 16, and a second metal fluoride layer 18. The substrate 12 includes a primary surface 20. In use, the primary surface 20 is oriented toward incident electromagnetic radiation 22 that the mirror 10 is configured to reflect. In embodiments, the substrate 12 includes a composition of any one of SiO₂, Ni-plated Al, CaF₂, Si, and ultra-low expansion (ULE) glass. Ultra-low expansion glass can exhibit a coefficient of thermal expansion (CTE) at 20° C. that is within a range of from −45 ppb/K to +20 ppb/K. An example of an ultra-low expansion glass is silica-titania glass, such as ULE® (Corning Incorporated, Corning, New York, USA). In embodiments, the primary surface 20 of the substrate 12 exhibits a surface roughness (RMS) that is less than or equal to 25 Å, such as less than or equal to 10 Å. For example, the surface roughness (RMS) that the primary surface 20 exhibits is 5 Å, 6 Å, 7 Å, 8 Å, 9 Å, 10 Å, 11 Å, 12 Å, 13 Å, 14 Å, 15 Å, 16 Å, 17 Å, 18 Å, 19 Å, 20 Å, 21 Å, 22 Å, 23 Å, 24 Å, 25 Å, or within any range bound by any two of those values (e.g., from 8 Å to 14 Å, from 10 Å to 15 Å, and so on). The surface roughness (RMS) that the primary surface 20 of the substrate 12 exhibits can be determined using an optical surface profiler (e.g., Zygo New View). As further illustrated in the Examples below, the surface roughness (RMS) of the substrate 12 affects the reflectance of the mirror 10.

As mentioned, the mirror 10 includes the aluminum layer 14. The aluminum layer 14 is disposed on the primary surface 20 of the substrate 12. The aluminum layer 14 has a thickness 24. The thickness 24 of the aluminum layer 14 is orthogonal to the primary surface 20 of the substrate 12. The thickness 24 of the aluminum layer 14 is within a range of from 50 nm to 100 nm. For example, the thickness 24 of the aluminum layer 14 can be 50 nm, 55 nm, 60 nm, 65 nm, 70 nm, 75 nm, 80 nm, 85 nm, 90 nm, 95 nm, 100 nm, or within any range bound by any two of those values (e.g., from 55 nm to 80 nm, from 85 nm to 95 nm, and so on). The thickness 24 of the aluminum layer 14 can be determined via atomic force microscopy of a cross-section of the mirror 10 orthogonal to the primary surface 20 of the substrate 12.

As mentioned, the mirror 10 includes an MgF₂ layer 16. The MgF₂ layer 16 is disposed on the aluminum layer 14, with the aluminum layer 14 disposed between the primary surface 20 of the substrate 12 and the MgF₂ layer 16. The MgF₂ layer 16 has a thickness 26. The thickness 26 of the MgF₂ layer 16 is orthogonal to the primary surface 20 of the substrate 12. The thickness 26 of the MgF₂ layer 16 is within a range of from 3.0 nm to 7.0 nm. For example, the thickness 26 of the MgF₂ layer 16 can be 3.1 nm, 3.2 nm, 3.3 nm, 3.4 nm, 3.5 nm, 3.6 nm, 3.7 nm, 3.8 nm, 3.9 nm, 4.0 nm, 4.1 nm, 4.2 nm, 4.3 nm, 4.4 nm, 4.5 nm, 4.6 nm, 4.7 nm, 4.8 nm, 4.9 nm, 5.0 nm, 5.1 nm, 5.2 nm, 5.3 nm, 5.4 nm, 5.5 nm, 5.6 nm, 5.7 nm, 5.8 nm, 5.9 nm, 6.0 nm, 6.1 nm, 6.2 nm, 6.3 nm, 6.4 nm, 6.5 nm, 6.6 nm, 6.7 nm, 6.8 nm, 6.9 nm, 7.0 nm, or within any range bound by any two of those values (e.g., from 3.0 nm to 5.0 nm, from 3.3 nm to 3.9 nm, from 4.1 nm to 4.8 nm, and so on). The lower end of that range—3.0 nm—is thought to be the minimum thickness 26 for the MgF₂ layer 16 to protect the aluminum layer 14 from oxidation after the aluminum layer 14 is deposited upon the primary surface 20 of the substrate 12. Values for the thickness 26 of less than 3.0 nm would not sufficiently protect the aluminum layer 14 from oxidation, which would hinder the reflectance that the mirror 10 exhibits at VUV wavelengths. The upper end of that range −7.0 nm—is thought to be the maximum value for the thickness 26 for the MgF₂ that does not suboptimally hinder reflectance. Values for the thickness 26 greater than 7.0 nm would suboptimally hinder reflectance that the mirror 10 exhibits at VUV wavelengths. As further detailed in the Examples below, higher values for the thickness 26 of the MgF₂ layer 16 appear to reduce reflectance of wavelengths under 120 nm to a surprisingly high degree. MgF₂ has a reflectance cutoff of about 115 nm and thus is a driver of hindering the ability of the mirror 10 to reflect wavelengths of about 115 nm and shorter. The thickness 26 of the MgF₂ layer 16 can be determined via atomic force microscopy of a cross-section of the mirror 10 orthogonal to the primary surface 20 of the substrate 12.

In embodiments, the mirror 10 is substantially free of a layer of Al₂O₃ disposed between the aluminum layer 14 and the MgF₂ layer 16. As will be discussed further below, the MgF₂ layer 16 can be deposited very quickly (e.g., “flash” deposition) after the formation of the aluminum layer 14. The flash deposition of the MgF₂ layer 16 substantially prevents oxidation of the aluminum layer 14. Characterization tools such as ToF-SIMS and cross-section SEM-EDX can be used to analyze the mirror 10 to determined whether an observable layer of Al₂O₃ has formed between the aluminum layer 14 and the MgF₂ layer 16. The degraded reflectivity of the mirror 10 could be a direct non-destructive way to observe the presence of a layer of Al₂O₃.

As mentioned, the mirror 10 includes the second metal fluoride layer 18. The second metal fluoride layer 18 is disposed over the MgF₂ layer 16. The MgF₂ layer 16 is disposed between the aluminum layer 14 and the second metal fluoride layer 18. The second metal fluoride layer 18 has a thickness 28. The thickness 28 of the second metal fluoride layer 18 is orthogonal to the primary surface 20 of the substrate 12. The thickness 28 of the second metal fluoride layer 18 is within a range of from 5.0 nm to 40 nm. For example, the thickness 28 of the second metal fluoride layer 18 can be 5.0 nm, 7.0 nm, 10 nm, 12 nm, 15 nm, 17 nm, 20 nm, 22 nm, 25 nm, 27 nm, 30 nm, 32 nm, 35 nm, 37 nm, 40 nm, or within any range bound by any two of those values (e.g., from 10 nm to 30 nm, from 22 nm to 37 nm, and so on). The thickness 28 of the second metal fluoride layer 18 can be determined via atomic force microscopy of a cross-section of the mirror 10 orthogonal to the primary surface 20 of the substrate 12. The second metal fluoride layer 18 can be one or more of MgF₂, AlF₃, LiF, LaF₃, GdF₃, and CaF₂, although other options are envisioned.

In embodiments, the second metal fluoride layer 18 has a packing density that is higher than a packing density of the MgF₂ layer 16. Packing density is a measure of closeness to theoretical bulk density for a substance. Thus, a layer having a packing density of 0.7 means that the layer is 70% of the theoretical bulk density of the material making the layer. Packing density can thus be analogized to porosity, where as the packing density decreases, the porosity of the layer increases. Packing density is relevant to vapor deposition processes because the vaporized material condenses nearly molecule-by-molecule on the substrate 12. Thus, “higher packing density” means that the second metal fluoride layer 18 is closer to the theoretical bulk density of the second metal fluoride layer 18 than the MgF₂ layer 16 is to the theoretical bulk density of MgF₂. Relative packing density can be a consequence of the parameters of the vapor deposition process used to form the particular layer. This point is expanded upon below. The theoretical bulk densities for MgF₂, AlF, and LiF are 3.15 g/cm³, 3.10 g/cm³, and 2.64 g/cm³, respectively.

The refractive index of a layer, such as the second metal fluoride layer 18 and separately the MgF₂ layer 16, is proportional to the packing density of the layer. The greater the packing density, the greater the refractive index. More specifically, the relationship of layer packing density vs refractive index is: Porosity (P)=volume of solid part of layer/total volume of layer. Refractive index of the layer is: nₗ=(1−P)nᵥ+P*nₛ, where nₛ is the refractive index of solid and nᵥ is the index of the material filling the voids. If packing density=1, then nₗ=nₛ.

In embodiments, the second metal fluoride layer 18 provides an external surface 30 of the mirror 10. The external surface 30 that the second metal fluoride layer 18 provides exhibits a surface roughness (RMS) that is less than or equal to 10 Å. For example, the surface roughness (RMS) that the external surface 30 of the mirror 10 exhibits is 5 Å, 6 Å, 7 Å, 8 Å, 9 Å, 10 Å, or within any range bound by any two of those values (e.g., from 5 Å to 7 Å, from 6 Å to 9 Å, and so on). The surface roughness (RMS) that the external surface 30 of the second metal fluoride layer 18 exhibits can be determined using an optical surface profiler, as mentioned. The electromagnetic radiation 22 encounters the external surface 30 at an angle of incidence 32 that is relative to a normal to the external surface 30.

The mirror 10 of the present disclosure exhibits improved reflectance of shorter VUV wavelengths. For example, the mirror 10 exhibits greater than 70% reflectance at an angle of incidence of 15 degrees of electromagnetic radiation 22 throughout an entirety of a wavelength range of from 115 nm to 120 nm. Such reflectance can be greater than 70%, 71%, 72%, 73%, 74%, 75%, 76%, 77%, 78%, 79%, 80%, 81%, 82%, 83%, 84%, 85%, 86%, 87%, 88%, 89%, or even 90%, or within any range bound by any two of those values (e.g., from 80% to 88%, from 85% to 90%, and so on). In embodiments, the mirror 10 exhibits greater than 70% reflectance at an angle of incidence of 45 degrees of electromagnetic radiation 22 throughout an entirety of a wavelength range of from 115 nm to 120 nm. Such reflectance can be greater than 70%, 71%, 72%, 73%, 74%, 75%, 76%, 77%, 78%, 79%, 80%, 81%, 82%, 83%, 84%, 85%, 86%, 87%, 88%, 89%, or even 90%, or within any range bound by any two of those values (e.g., from 80% to 88%, from 85% to 90%, and so on). In embodiments, the mirror 10 exhibits greater than 70% reflectance at an angle of incidence of 45 degrees of electromagnetic radiation 22 at a wavelength of from 150 nm. Such reflectance can be greater than 70%, 71%, 72%, 73%, 74%, 75%, 76%, 77%, 78%, 79%, 80%, 81%, 82%, 83%, 84%, or even 85%, or within any range bound by any two of those values (e.g., from 71% to 83%, from 81% to 85%, and so on). In embodiments, the mirror 10 exhibits greater than 70% reflectance at an angle of incidence of 45 degrees of electromagnetic radiation 22 throughout an entirety of a wavelength range of from 115 nm to 220 nm. Such reflectance can be greater than 70%, 71%, 72%, 73%, 74%, 75%, 76%, 77%, 78%, 79%, 80%, 81%, 82%, 83%, 84%, or even 85%, or within any range bound by any two of those values (e.g., from 71% to 83%, from 81% to 85%, and so on).

Reflectance of the mirror 10 as a function of wavelength can be determined using a VUV spectrophotometer. Unless otherwise specified, the reflectance values recited herein are as measured without any predetermined minimum ageing.

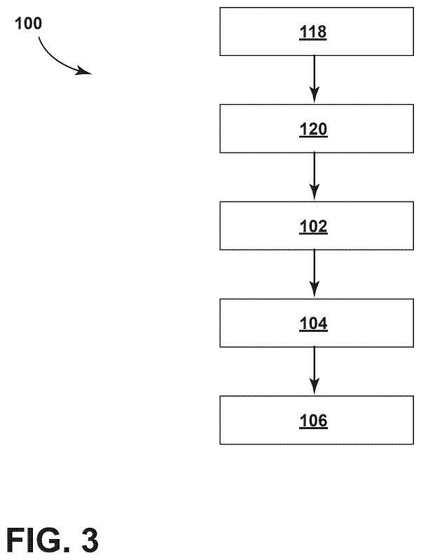

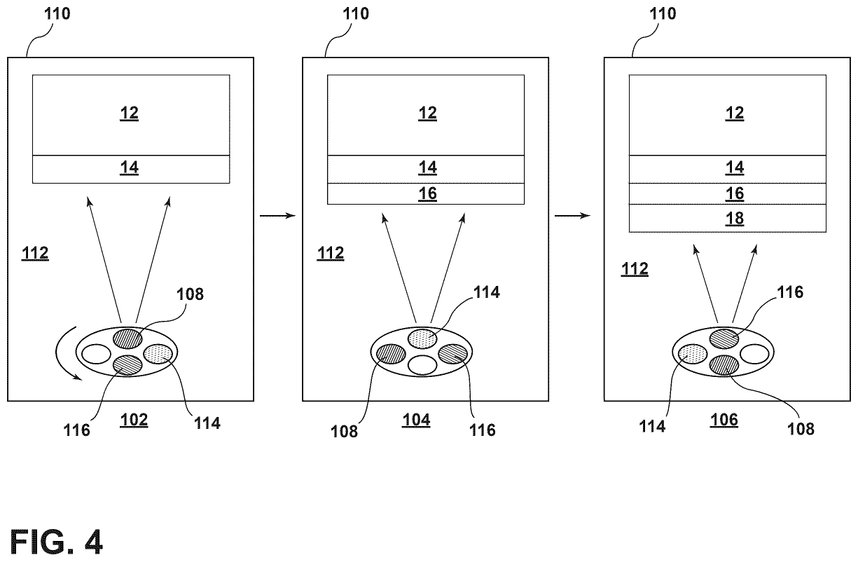

Referring now to FIGS. 3 and 4, a method 100 of making the mirror 10 of the present disclosure is herein described. The method 100 includes a first vapor deposition step 102, a second vapor deposition step 104, and a third vapor deposition step 106.

The first vapor deposition step 102 includes vaporizing an aluminum source material 108 with an energy source within a vacuum chamber 110. The substrate 12 is also within the vacuum chamber 110. The vacuum chamber 110 has an internal environment 112 to which the aluminum source material 108 and the substrate 12 are exposed that is at near-vacuum pressure (e.g., within a range of from 3×10−7 Torr to 5×10−7 Torr, with low O₂ partial pressure of less than 4.2×10−8 Torr). The vaporization of the aluminum source material 108 forms vaporized aluminum throughout the vacuum chamber 110. The vaporized aluminum moves from the aluminum source material 108 and condenses upon the primary surface 20 of the substrate 12. Condensation of the vaporized aluminum forms the aluminum layer 14 on the primary surface 20 of the substrate 12. As detailed above, in embodiments, the substrate 12 upon which the aluminum layer 14 is deposited during the first vapor deposition step 102 has a composition that can include SiO₂, Ni-plated Al, pure Al, CaF₂, Si, or ultra-low expansion glass.

In embodiments, during the first vapor deposition step 102, a physical vapor deposition energy source vaporizes the source of aluminum. In embodiments, the physical vapor deposition energy source is an electron beam (e.g., e-beam). Further, during the first vapor deposition step 102, the internal environment 112 within the vacuum chamber 110 can have a first temperature of about room temperature (e.g., 20° C. to 30° C.). Moreover, during the first vapor deposition step 102, the aluminum condenses on the substrate 12 at a rate within a range of from 50 nm/second to 100 nm/second until the thickness 24 of the aluminum layer 14 is greater than or equal to 50 nm, such as within a range of from 50 nm to 100 nm. At the thickness 24 of 50 nm, the aluminum layer 14 begins to behave, from a reflectance point of view, sufficiently like bulk aluminum. Thicknesses greater than 100 nm serve no reflectance related purpose, as the aluminum layer 14 reflects substantially the same as bulk aluminum. Once the vapor deposition achieves that thickness 24, the first vapor deposition step 102 ceases.

As mentioned, the method 100 includes the second vapor deposition step 104. The second vapor deposition step 104 includes vaporizing an MgF₂ source material 114. The energy source that was used to vaporize the aluminum source material 108 during the first vaporization step 102 can be utilized to vaporize the MgF₂ source material 114 during the second vapor deposition step 104. For example, if an electron beam was utilized during the first vapor deposition step 102, then the electron beam can additionally utilized for the second vapor deposition step 104. However, that need not be the case, and different energy sources can be utilized to vaporize the aluminum source material 108 during the first vaporization step 102 and to vaporize the MgF₂ source material 114 during the second vapor deposition step 104.

The second vapor deposition step 104 occurs in the vacuum chamber 110 where the first vapor deposition step 102 occurred. The substrate 12 with the aluminum layer 14 remains in the vacuum chamber 110 during the transition from the first vapor deposition step 102 to the second vapor deposition step 104. These measures help reduce the transition time between the first vapor deposition step 102 and the second vapor deposition step 104. Reducing the transition time reduces the amount of oxidation that occurs on the aluminum layer 14 before the second vapor deposition step 104 commences.

Like the first vapor deposition step 102, the internal environment 112 within the vacuum chamber 110 during the second vapor deposition step 104 can have a second temperature that is also about room temperature (e.g., 20° C. to 30° C.). Further, in embodiments, the second vapor deposition step 104 commences without the near-vacuum pressure within the vacuum chamber 110 having substantially changed after completion of the first vapor deposition step 102.

The vaporization of the MgF₂ source material 114 forms vaporized MgF₂ within the vacuum chamber 110. The vaporized MgF₂ moves from the MgF₂ source material 114 and condenses upon the aluminum layer 14. Condensation of the vaporized MgF₂ forms the MgF₂ layer 16 on the aluminum layer 14, which is on the primary surface 20 of the substrate 12. The packing density ratio for the flash-deposited MgF₂ layer at room temperature is about 0.75.

Without being bound by theory, it is believed that MgF₂ is better suited to protect the aluminum layer 14 from oxidation than other metal fluorides, because e-beam causes the MgF₂ source material 114 to quickly melt into a puddle, gently vaporize, and condense on the aluminum layer 14 in a stable manner. In contrast, AlF₃ source material, for example, does not tolerate e-beam well. The e-beam causes the Al to disassociate from the F₃ and thus AlF₃ does not condense on the aluminum layer 14 in a stable manner. Further, AlF₃ is hygroscopic, which facilitates oxidation of the aluminum layer 14, while MgF₂ is not hygroscopic. Likewise, LiF is hygroscopic, more hygroscopic than AlF₃, rendering LiF unsuitable instead of MgF₂.

The second vapor deposition step 104 commences within 20 seconds after completion of the first vapor deposition step 102. The 20-second time period is thought important to minimize oxidation of the aluminum layer 14. Preferably, the second vapor deposition step 104 commences as soon as possible, such as within about 10 seconds. As discussed, minimizing oxidation is important because aluminum oxide is a much worse reflector of VUV wavelengths than aluminum metal. Waiting longer than the 20-seconds maximum will allow the aluminum layer 14 to have oxidized to a suboptimal degree. The MgF₂ source material 114 may require pre-melting to prevent “spit” or particulate during evaporation from a solid crystal form. The MgF₂ does not sublimate. MgF₂ is an intrinsic non-sublime fluoride material, once pre-melting preparation process is done, the pre-soak and warm up transition time between the first vapor deposition step 102 and the second vapor deposition step 104 can be controlled to be less than or equal to 20 seconds therebetween. During standard vapor deposition processes, heating time before vapor deposition can begin can take as long as one hour. Thus, the 20-seconds maximum for the second vapor deposition step 104 is a stark difference. In embodiments, the second vapor deposition step 104 begins before measurable oxidation of the aluminum layer 14 occurs. Measurable oxidation of the aluminum layer 14 to Al₂O₃ is present when the reflectance spectra of the mirror 10 shows a significant drop (e.g., greater than or equal to 20%) at wavelengths shorter than 170 nm compared to, for example, a wavelength of 220 nm. The lack of such a drop at wavelengths shorter than 170 nm thus signifies a lack of measurable oxidation of the aluminum layer 14.

The MgF₂ layer 16 can be thought of as an immediate (relatively so) or “flash-deposited” barrier layer over the aluminum layer 14 that was freshly deposited as well to minimize oxidation of the aluminum layer 14. Flash deposition of the MgF₂ layer 16 on to freshly deposited aluminum layer 14 minimizes the time of exposure of the surface of aluminum layer 14 to the ambient of the vacuum chamber 110 and thus reduces the likelihood of oxidation. A flash-deposited MgF₂ layer 16 covers the surface of aluminum layer 14 and acts as a barrier that inhibits migration of oxidizing species to the surface to minimize oxidation thereof.

During the second vapor deposition step 104, the MgF₂ condenses until the thickness 26 of the MgF₂ layer 16 is within a range of from 3.0 nm to 5.0 nm. Once the vapor deposition achieves that thickness 26, the second vapor deposition step 104 ceases.

As mentioned, the method 100 further includes the third vapor deposition step 106. The third vapor deposition step 106 occurs after the second vapor deposition step 104. The third vapor deposition step 106 includes vaporizing a metal fluoride source material 116 with an energy source within a vacuum chamber 110. The substrate 12 with the aluminum layer 14 thereupon and the MgF₂ layer 16 upon the aluminum layer 14 is also within the vacuum chamber 110. The vaporization of the metal fluoride source material 116 forms vaporized metal fluoride within the chamber. The vaporized metal fluoride moves from the metal fluoride source material 116 and condenses upon MgF₂ layer 16. Condensation of the vaporized metal fluoride forms the second metal fluoride layer 18 on the MgF₂ layer 16 (the MgF₂ layer 16 being the first metal fluoride layer).

During the third vapor deposition step 106, the metal fluoride condenses until the thickness 28 of the second metal fluoride layer 18 is as desired and is greater than the thickness 26 of the MgF₂ layer 16. Once the vapor deposition achieves the thickness 28 desired, the third vapor deposition step 106 ceases. As stated above, the second metal fluoride layer 18 can be made of any one or more of MgF₂, AlF₃, LiF, LaF₃, GdF₃, and CaF₂, and the thickness 28 of the second metal fluoride layer 18 can be within the range of from 5.0 nm to 40 nm. Reflectance for MgF₂ falls at wavelengths shorter than about 116 nm. Reflectance for AlF₃ falls at wavelengths shorter than about 115 nm. Reflectance for LiF falls at wavelengths shorter than about 104 nm. Reflectance for both LaF₃ and GdF₃ fall at wavelengths shorter than about 140 nm. Reflectance for CaF₂ falls at wavelengths shorter than about 125 nm. The metal fluoride chosen for the second metal fluoride layer 18 and the thickness 28 thereof are chosen as a pair to promote the VUV reflectance of the mirror 10. This point is expanded upon in the Examples below.

Further, the third vapor deposition step 106 is conducted so that the second metal fluoride layer 18 has a packing density that is greater than the packing density of the MgF₂ layer 16. For example, to cause the second metal fluoride layer 18 to form with the packing density that is greater than the packing density with which the MgF₂ layer 16 was formed, the internal environment 112 within the vacuum chamber 110 during the third vapor deposition step 106 has a third temperature that is greater than the second temperature at which the second vapor deposition step 104 occurred. The third temperature, being greater than the second temperature, results in the packing density of the second metal fluoride layer 18 being greater than the packing density of the MgF₂ layer 16. The packing density of the second metal fluoride layer 18 being greater is desirable, because the higher the packing density, the greater the aluminum layer 14 is protected from oxidation. In embodiments, the third temperature at which the third vapor deposition step 106 occurs is within a range of from 200° C. to 300° C. For example, the third temperature can be 200° C., 210° C., 220° C., 230° C., 240° C., 250° C., 260° C., 270° C., 280° C., 290° C., 300° C., or within any range bound by any two of those values (e.g., from 210° C. to 260° C., from 230° C. to 280° C., and so on). The third temperature, being greater than the second temperature, may also increase the packing density of the MgF₂ layer 16. However, that too is beneficial to reducing the rate at which the aluminum layer 14 oxidizes and does not reduce VUV reflectance of the mirror 10.

The third vapor deposition step 106 generates the second metal fluoride layer 18 with the packing density that is greater than the packing density of the MgF₂ layer 16, and thus affords greater overall protection to the aluminum layer 14 from oxidation. However, the relatively high third temperature is needed to generate the increased packing density, and it takes time (e.g, up to an hour) to bring the internal environment 112 of the vacuum chamber 110 to the increased temperature. That is one reason why the “flash” MgF₂ layer 16 is advantageous. The MgF₂ layer 16 is quickly added at about room temperature after the formation of the aluminum layer 14 and provides a measure of oxidation protection while the vacuum chamber 110 is brought to the increased third temperature for the third vapor deposition step 106.

In embodiments, the method 100 further includes a polishing step 118. The polishing step 118 occurs before the first vapor deposition step 102. The polishing step 118 includes polishing the primary surface 20 of the substrate 12 so that the surface roughness (RMS) thereof is as stated above for the primary surface 20, e.g., is less than or equal to 10 Å.

In embodiments, the method 100 further includes a baking step 120. The baking step 120 occurs before the first vapor deposition step 102 and after the polishing step 118, if the polishing step 118 is performed. The baking step 120 includes subjecting the substrate 12 to the internal environment 112 within the vacuum chamber 110 to a baking temperature above 130° C. for a baking time period of at least 8 hours. The baking step 120 reduces the water partial pressure, further reducing the ability of the aluminum layer 14, subsequently applied, to oxidize.

The present disclosure addresses the problem described in the Background, in several ways. The MgF₂ layer 16 is quickly applied over the fresh aluminum layer 14 and offers stop-gap oxidation prevention of the aluminum layer 14 until the second metal fluoride layer 18 can be applied. The second metal fluoride layer 18, being thicker than the MgF₂ layer and having higher packing density than the MgF₂ layer, offers longer term protection against oxidation of the aluminum layer 14. Together, the MgF₂ layer and the second metal fluoride layer 18 prevent or minimize oxidation of the aluminum layer 14 both during manufacture of the mirror 10 and over the longer-term use of the mirror 10. The MgF₂ layer 16, being only several nanometers thick, only minimally adversely affects VUV reflectance, if at all.

### EXAMPLES

Example 1 and Comparative Examples 1A and 1B—For Example 1, a mirror of the present disclosure was made pursuant to the method of the present disclosure. In particular, the first vapor deposition step, the second vapor deposition step, and the third vapor deposition step were performed in a vacuum chamber equipped with three turbo and two cryo pumps that were able to achieve near vacuum pressure. The deposition rates of the respective layers resulting from each deposition step were controlled by quartz crystal monitoring. The first vapor deposition step produced the aluminum layer on the substrate of SiO₂. The second vapor deposition step produced the flash MgF₂ layer. The third vapor deposition step produced the second metal fluoride layer of LiF.

For Comparative Examples 1A and 1B, the second vapor deposition step to apply the flash MgF₂ layer was not conducted. Rather, for both comparative examples, a layer of MgF₂ was applied directly over the aluminum layer. The layer of MgF₂ in both instances was of a thickness and packing density intended to protect the aluminum layer from oxidation.

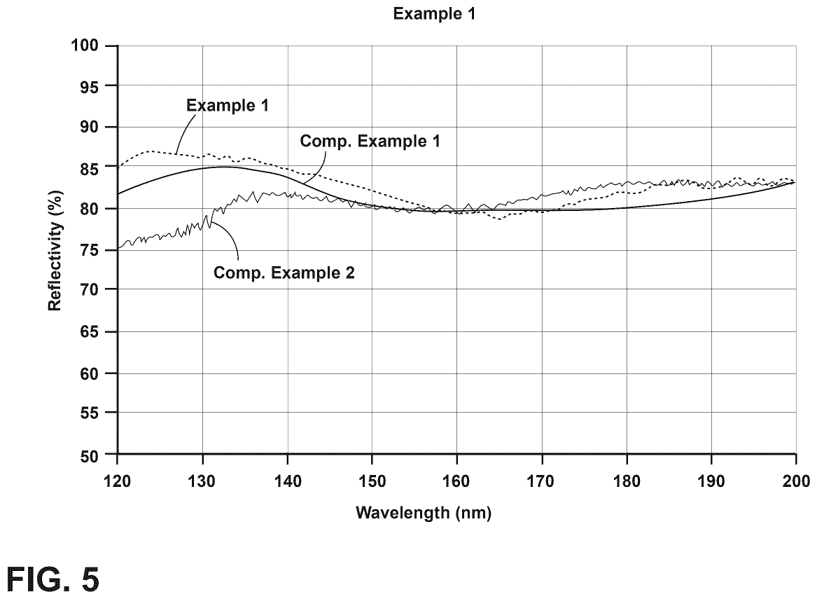

The reflectance spectra for Example 1 and Comparative Examples 1A and 1B were then measured on a McPherson VUVAS spectrophotometer. The reflectance spectra are reproduced in FIG. 5. As the graph of FIG. 5 reveals, Example 1 exhibited a greater reflectance than Comparative Examples 1A and 1B throughout the entirety of the wavelength range of from 120 nm to 155 nm. The angle of incidence was 15 degrees.

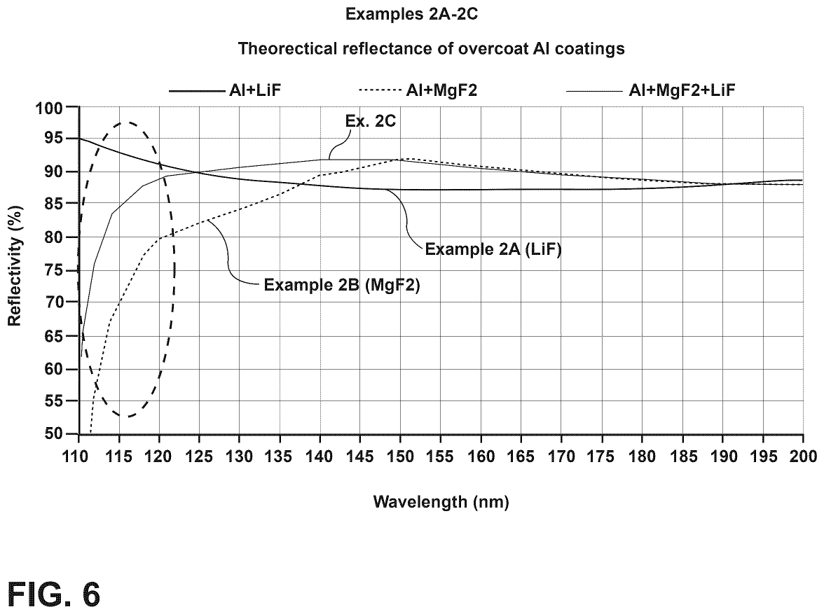

Examples 2A-2C—For Examples 2A-2C, computer simulations were performed to determine the theoretical reflectance spectra as a function of the particular metal fluoride chosen as the metal fluoride layer to protect the aluminum layer. Example 2A was a LiF layer over the aluminum layer. Example 2B was an MgF₂ layer over the aluminum layer. Example 2C was a combined MgF₂ and LiF bilayer over the aluminum layer, with the LiF portion of the bilayer being 5 times as thick as the MgF₂ portion. The packing densities for all three examples were less than 1.0. The computer modeled reflectance spectra are reproduced in FIG. 6.

As the reflectance spectra shows, the reflectance spectra are sensitive to the specific metal fluoride applied to protect the aluminum layer from oxidation, especially at shorter wavelengths (e.g., shorter than 135 nm). The LiF layer (Example 2A) results in relatively high reflectance throughout the wavelength range of 110 nm to 120 nm but reflectance drops above 120 nm to around 150 nm. The MgF₂ layer (Example 2B) shows relatively low reflectance of wavelengths shorter than 135 nm and drastically lower reflectance of wavelengths shorter than 120 nm. The combined MgF₂ and LiF layer (Example 2C) shows better reflectivity at the wavelength range of 115 nm to 120 nm but the reflectivity still drops off for wavelengths shorter than 112 nm or so.

Comparative Example 3A and Examples 3B-3H—For Examples 3B-3H, seven different mirrors of the present disclosure were made via the method of the present disclosure. During the manufacture of each of the eight mirrors, the thickness of the MgF₂ layer applied over the aluminum layer, the metal fluoride chosen for the second metal fluoride layer applied over the MgF₂, and the thickness of the second metal fluoride layer were varied. Comparative Example 3A is a comparative example because the thickness of the MgF₂ layer is too high. Table 1 below shows the selections for each of the eight examples. The substrate for each of these examples was precision polished silica (DUV grade).

TABLE 1

| | MgF₂ Layer | Second | Second Metal |
|---|---|---|---|
| | Thickness | Metal | Fluoride Layer |
| Example | (nm) | Fluoride | Thickness (nm) |
| 3A | 10 | LiF | 25 |
| 3B | 5 | LiF | 20 |
| 3C | 4 | LiF | 24 |
| 3D | 4 | LiF | 28 |
| 3E | 6 | LiF | 24 |
| 3F | 4 | AlF₃ | 25 |
| 3G | 4 | LiF | 14 |
| 3H | 4 | MgF₂ | 20 |

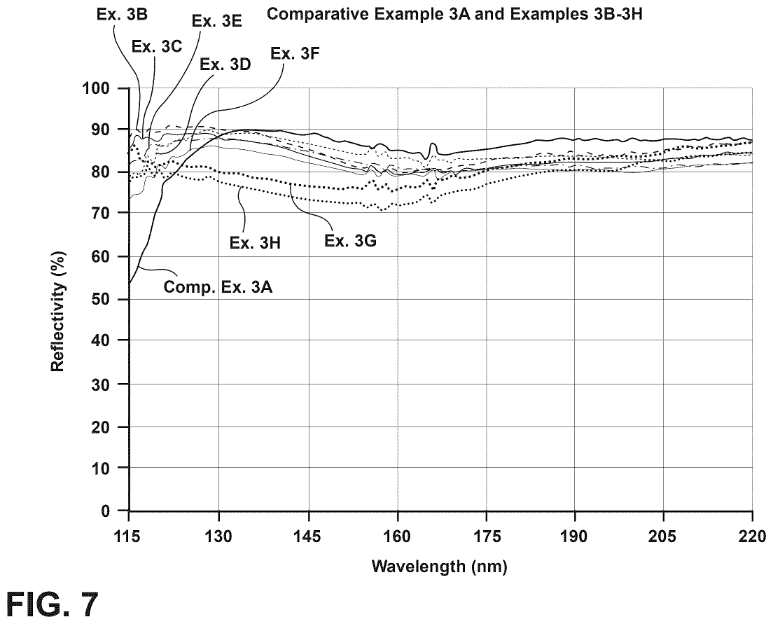

The reflectance spectra for each of the examples were then determined, for an angle of incidence of 15 degrees. A graph of the reflectance spectra is reproduced in FIG. 7. As the graph reveals, for the mirror to exhibit a reflectance of greater than 80% through the entirety of the wavelength range of from 115 nm to 160 nm, all three variables need to be considered. More particularly, increasing the thickness of the MgF₂ layer past a threshold, as with Comparative Example 3A, appears to have a bearing on lowering the reflectance from 115 nm to 120 nm, as does relatively high thickness for the second metal fluoride layer when AlF₃ is chosen as the second metal fluoride. In reference to Comparative Example 3A, it was unexpected that the thicker MgF₂ layer of 10 nm would so substantially reduce the reflectance for wavelengths shorter than 120 nm. Accordingly, it is preferable for the thickness of the MgF₂ layer to be greater than 3.0 nm as noted above and less than less than 7.0 nm. Other conclusions can be drawn.

Examples 4A-4D—For Examples 4A-4D, the effect of surface roughness of the substrate on reflectance was studied. All four examples included a substrate, an MgF₂ layer (thickness of 4.0 nm) over the substrate, and a LiF second metal fluoride layer (thickness of 26.0 nm) over the MgF₂ layer made pursuant to the method of the present disclosure. The particularities of each example are set forth in Table 2 below.

TABLE 2

| | | Surface |
|---|---|---|
| | | Roughness |
| Example | Substrate | (RMS) (Å) |
| 4A | SiO₂ (Quartz) | Less than 5 |
| 4B | Ni-plated Al | 20 |
| 4C | Surface | 30-40 |
| | modified | |
| | pure Al | |
| 4D | Ni-plated Al | 10 |

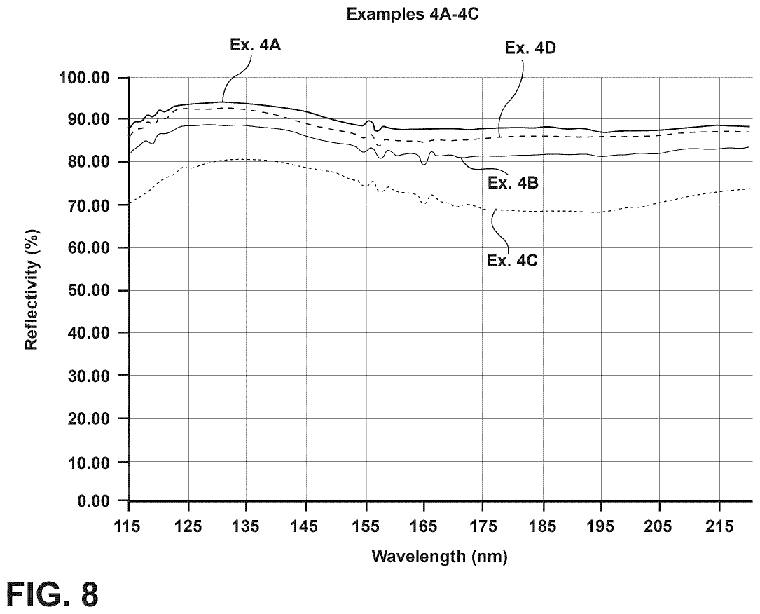

Reflectance spectra were then obtained for each example. A graph showing the results is reproduced in FIG. 8. As the graph reveals, the reflectance of the mirror decreases as the surface roughness of the substrate increases.

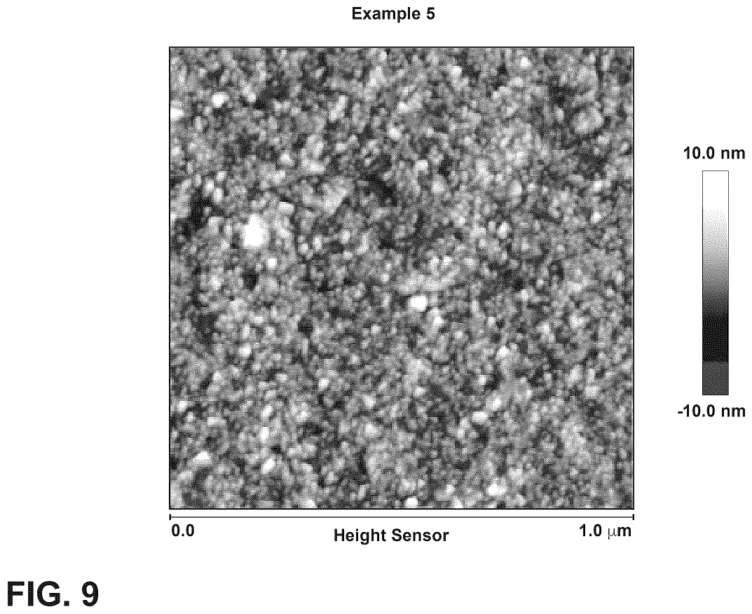

Example 5—For Example 5, a mirror of the present disclosure was made pursuant to the method of the present disclosure. The substrate used was SiO₂. The second metal fluoride layer was made of LiF. An image and surface analysis of the mirror were captured via atomic force microscopy. The image is reproduced at FIG. 9. The surface analysis reveals that the second metal fluoride layer provides the mirror with a surface roughness (RMS) of about 8 Å, which is similar to the bare SiO₂ substrate before the method is performed.

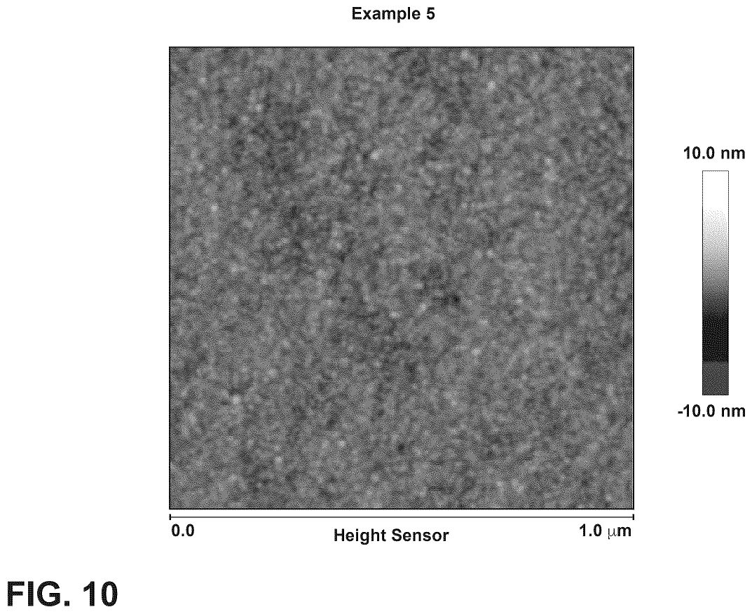

Examples 6A-6C—For Examples 6A-6C, three mirrors of the present disclosure were made pursuant to the method of the present disclosure. For Example 6A, the substrate used was SiO₂. For Examples 6B and 6C, the substrate used was Ni-plated Al. The MgF₂ layer in all three examples had a thickness of 4.0 nm. The second metal fluoride layer was made of AlF₃ for all three mirrors. The primary surfaces of the substrate of all three mirrors were polished to exhibit a surface roughness (RMS) of less than 5 Å for the SiO₂ substrate of Example 6A and less than 10 Å for the Ni-plated Al of Examples 6B and 6C. An image and surface analysis of the mirror of Example 6A were captured via atomic force microscopy. The image is reproduced in FIG. 10. The surface analysis reveals that the second metal fluoride layer provides the mirror with a surface roughness (RMS) of about 6 Å, which is similar to the bare SiO₂ substrate before the method is performed.

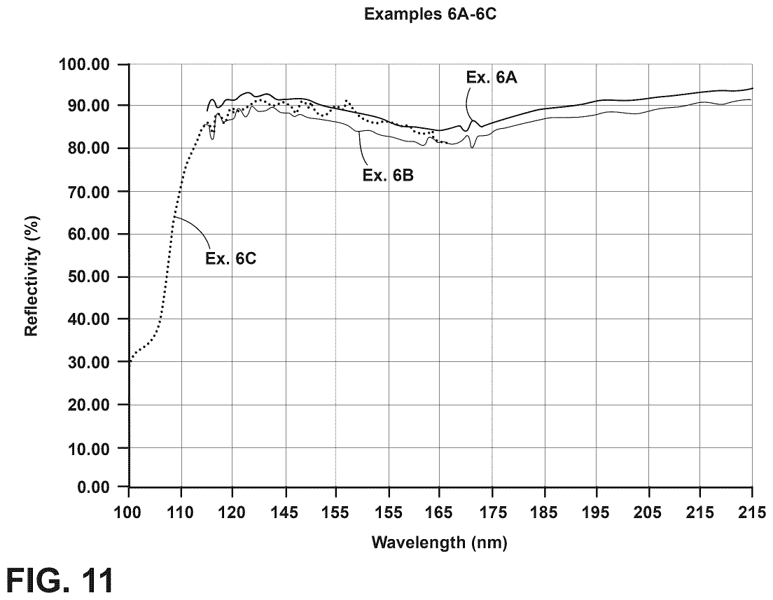

In addition, reflectance spectra for all three mirrors were obtained at an angle of incidence of 15 degrees. The reflectance spectra are reproduced in FIG. 11. The graph reveals that the mirror Example 6A with the SiO₂ substrate had higher reflectance than the mirrors of Examples 6B and 6C with the Ni-coated Al substrate. The mirrors of all three examples exhibit reflectance of greater than 80% throughout the entirety of the wavelength range of from 115 nm to 300 nm.

The graph of FIG. 11 reveals a drop in reflectance around the wavelength of 160 nm. This reflectance drop could be explained in terms of surface plasmon excitation. Surface plasmon (the plasmon can be considered as a quasiparticle since it arises from the quantization of plasma oscillations), excitation would occur on the surface of the mirror and induce reflectance drop at the surface plasmon wavelength (λₛₚ). The surface plasmon wavelength (λₛₚ) is ˜117 nm at the Al/vacuum interface but would shift to higher λ(˜157 nm) when Al is covered with the second metal fluoride layer.

Example 7A and Comparative Example 7B—For Example 7A, a mirror of the present disclosure was made according to the method of the present disclosure. More particularly, the substrate was made of SiO₂. The aluminum layer was disposed over the substrate and protected by the “flash” MgF₂ layer. The second metal fluoride layer disposed on the MgF₂ layer was made of AlF₃. For Comparative Example 7B, a mirror was made without the “flash” MgF₂ layer formed according to the second vapor deposition step of the present disclosure. More particularly, Ni-plated Al was the substrate. The aluminum layer was disposed over the substrate but with no subsequent “flash” MgF₂ layer as mentioned. A thick MgF₂ layer was then deposited on the aluminum layer.

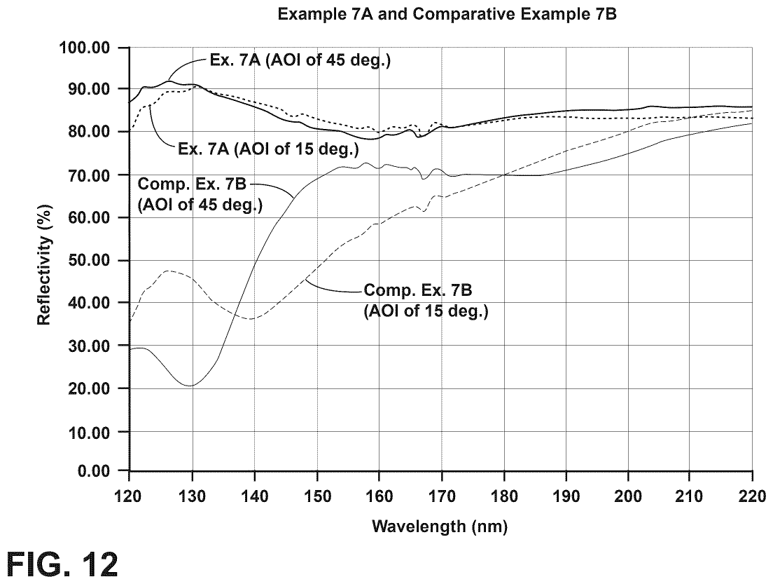

Reflectance spectra for both mirrors were obtained at an angle of incidence (AOI) of 15 degrees and, separately, an angle of incidence (AOI) of 45 degrees. The reflectance spectra are reproduced in FIG. 12. The graph reveals that the mirror of the present disclosure with the MgF₂ layer flash deposited exhibited much higher reflectance, especially throughout the wavelength range of from 120 nm to 160 nm, than the mirror without a flash-deposited MgF₂ layer. The sharp drop in reflectance that the mirror of Comparative Example 7B exhibited at wavelengths shorter than 170 nm indicates the presence of Al₂O₃ between the aluminum layer applied over the substrate and the metal fluoride protection layer. In short, the aluminum layer of the mirror of Comparative Example 7B oxidized to a degree sufficient to hinger the reflectance that the mirror exhibited, while the aluminum layer of the mirror of Example 7A did not.

1. A mirror comprising:
a substrate comprising a primary surface;
an aluminum layer disposed on the primary surface of the substrate, the aluminum layer comprising a thickness within a range of from 50 nm to 100 nm;
an MgF₂ layer disposed on the aluminum layer, the MgF₂ layer comprising a thickness within a range of from 3.0 nm to 7.0 nm; and
a second metal fluoride layer disposed on the MgF₂ layer, the second metal fluoride layer comprising a thickness within a range of from 5.0 nm to 40 nm,
wherein, the mirror exhibits greater than 70% reflectance at an angle of incidence of 15 degrees of electromagnetic radiation throughout an entirety of a wavelength range of from 115 nm to 120 nm.

2. The mirror of claim 1, wherein the substrate comprises a composition of one or more of SiO₂, Ni-plated Al, pure Al, CaF₂, Si, and ultra-low expansion glass.

3. The mirror of claim 1, wherein the primary surface of the substrate upon which the aluminum layer is disposed exhibits a surface roughness (RMS) that is less than or equal to 10 Å.

4. The mirror of claim 1, wherein the mirror is substantially free of a layer of Al₂O₃ disposed between the aluminum layer and the MgF₂ layer.

5. The mirror of claim 1, wherein the thickness of the second metal fluoride layer is within a range of from 10 nm to 30 nm.

6. The mirror of claim 1, wherein the second metal fluoride layer comprises one or more of MgF₂, AlF₃, LiF, LaF₃, GdF₃, and CaF₂.

7. The mirror of claim 1, wherein the second metal fluoride layer has a higher packing density than the MgF₂ layer.

8. The mirror of claim 1, wherein the second metal fluoride layer comprises an external surface that exhibits a surface roughness (RMS) that is less than or equal to 10 Å.

9. A method of making a mirror comprising:
a first vapor deposition step comprising vaporizing an aluminum source material with an energy source within a vacuum chamber at a near-vacuum pressure so that vaporized aluminum moves from the aluminum source material and condenses upon a substrate as an aluminum layer;
a second vapor deposition step commencing within 20 seconds after completion of the first vapor deposition step, the second vapor deposition step comprising vaporizing an MgF₂ source material with an energy source within the vacuum chamber so that vaporized MgF₂ moves from the MgF₂ source and condenses upon the aluminum layer as a MgF₂ layer having a thickness within a range of from 3.0 nm to 7.0 nm; and
a third vapor deposition step, occurring after the second vapor deposition step, comprising vaporizing a metal fluoride source material so that vaporized metal fluoride moves from the metal fluoride source and condenses upon the MgF₂ layer as a second metal fluoride layer comprising (i) a thickness that is greater than the thickness of the MgF₂ layer and (ii) a packing density that is greater than a packing density of the MgF₂ layer.

10. The method of claim 9, wherein during the first vapor deposition step, an electron beam vaporizes the source of aluminum.

11. The method of claim 9, wherein the substrate comprises a composition of one or more of SiO₂, Ni-plated Al, pure Al, CaF₂, Si, and ultra-low expansion glass.

12. The method of claim 9, wherein during the first vapor deposition step, the aluminum condenses on the substrate at a rate within a range of from 50 nm/second to 100 nm/second until the formation of the aluminum layer comprising a thickness within a range of from 50 nm to 100 nm is formed, at which thickness the first vapor deposition step ceases.

13. The method of claim 9, wherein the second vapor deposition step begins before measurable oxidation of the aluminum layer occurs.

14. The method of claim 9, wherein the second vapor deposition step commences without the near-vacuum pressure within the vacuum chamber substantially changing after completion of the first vapor deposition step.

15. The method of claim 9, wherein during the second vapor deposition step, an internal environment within the vacuum chamber has a second temperature; and during the third vapor deposition step, the internal environment within the vacuum chamber has a third temperature that is greater than the second temperature.

16. The method of claim 9, wherein
during the first vapor deposition step, an internal environment within the vacuum chamber has a first temperature of about room temperature;
during the second vapor deposition step, the internal environment within the vacuum chamber has a second temperature of about room temperature; and
the third vapor deposition step occurs at a temperature within a range of from 200° C. to 300° C.

17. The method of any one of claim 9, wherein the second metal fluoride layer comprises a metal fluoride of one or more of MgF₂, AlF₃, LiF, LaF₃, GdF₃, and CaF₂.

18. The method of claim 9, wherein the thickness of the second metal fluoride layer is within a range of from 5.0 nm to 40 nm.

19. The method of claim 9, further comprising:
a polishing step, occurring before the first vapor deposition step, comprising polishing the primary surface of the substrate to achieve a surface roughness (RMS) that is less than or equal to 10 Å.

20. The method of claim 9, further comprising:
a baking step, occurring before the first vapor deposition step, comprising subjecting the substrate, while in the vacuum chamber, to an internal environment comprising a baking temperature above 130° C. for a baking time period of at least 8 hours.
